(19) United States
(12) Patent Application Publication
(10) Pub. No.: US 2024/0411492 A1
(43) Pub. Date: Dec. 12, 2024

(54) IMAGE PROCESSING DEVICE, IMAGE PROCESSING METHOD, AND PROGRAM

(71) Applicant: Sony Group Corporation, Tokyo (JP)

(72) Inventor: Sho OGURA, Kanagawa (JP)

(73) Assignee: Sony Group Corporation, Tokyo (JP)

(21) Appl. No.: 18/701,937

(22) PCT Filed: Nov. 11, 2022
(86) PCT No.: PCT/JP2022/042051

§ 371 Date: Apr. 17, 2024

(30) Foreign Application Priority Data
Nov. 26, 2021 (JP) 2021-192470

(51) Int. Cl. G06F 3/14; G06T 7/20; G06T 17/00; G09G 5/373; G09G 5/377

(52) U.S. Cl. CPC G06F 3/14; G06T 7/20; G06T 17/00; G09G 5/373; G09G 5/377

(57) ABSTRACT

An image processing device includes: a display region determination unit that determines a first display region and a second display region different from the first display region from an input image; and a display control unit that causes an editing status confirmation display unit to display images of the first display region and the second display region determined by the display region determination unit as partial images.

### TECHNICAL FIELD

The present technology relates to an image processing device, an image processing method, and a program, and particularly relates to a technical field in which an input image is confirmed.

### BACKGROUND ART

Conventionally, a virtual reality (VR) technology has been proposed in which an input image such as an omnidirectional developed image which is an omnidirectional image of 360 degrees is viewed on a head mounted display or the like.

The omnidirectional developed image, which is an example of the input image, is generated by connecting a plurality of captured images obtained by capturing with a plurality of cameras by stitch processing. Then, the omnidirectional developed image obtained by the stitch processing is edited, and a final input image is generated (see, for example, Patent Document 1).

### CITATION LIST

### Patent Document

Patent Document 1: WO 2018/173791 A

### SUMMARY OF THE INVENTION

### Problems to be Solved by the Invention

By the way, the omnidirectional developed image is expressed by, for example, an equirectangular two-dimensional image. Therefore, in a case of confirming the omnidirectional developed image on the head mounted display, the user can confirm only a part of the omnidirectional developed image, but cannot confirm the other region.

The present technology has been made in view of such a problem, and an object thereof is to easily confirm an input image.

### Solutions to Problems

An image processing device according to the present technology includes: a display region determination unit that determines a first display region and a second display region different from the first display region from an input image; and a display control unit that causes an editing status confirmation display unit to display images of the first display region and the second display region determined by the display region determination unit as partial images.

As a result, the image processing device causes the display unit to display, for example, the partial image confirmed by the wearer on the head mounted display and other partial images.

### BRIEF DESCRIPTION OF DRAWINGS

FIG. 1 is a diagram illustrating a configuration of an image processing system.

FIG. 2 is a diagram for explaining a configuration of a VR conversion device.

FIG. 3 is a diagram for explaining a functional configuration of a VR conversion device.

FIG. 4 is a diagram for explaining a configuration of a plane conversion device.

FIG. 5 is a diagram for explaining a functional configuration of a plane conversion device.

FIG. 6 is a flowchart illustrating an outline of a flow of processing in a plane conversion device.

FIG. 7 is a diagram for explaining images displayed on a display unit and a head mounted display.

FIG. 8 is a diagram for explaining a first display mode.

FIG. 9 is a diagram for explaining a second display mode.

FIG. 10 is a diagram for explaining a third display mode.

FIG. 11 is a diagram for explaining a fourth display mode.

FIG. 12 is a diagram for explaining a fifth display mode.

FIG. 13 is a diagram for explaining a sixth display mode.

FIG. 14 is a diagram for explaining a case where a display region is moved rightward.

FIG. 15 is a diagram for explaining a case where a display region is moved upward.

FIG. 16 is a diagram for explaining a case where a display region is enlarged.

FIG. 17 is a diagram for explaining a case where a plurality of display regions is moved rightward.

FIG. 18 is a diagram for explaining a relationship with a partial image of a head mounted display.

FIG. 19 is a diagram for explaining a relationship with a partial image of a head mounted display.

FIG. 20 is a diagram for explaining an example of tracking display.

FIG. 21 is a diagram for explaining a display region corresponding to resolution of a head mounted display.

FIG. 22 is a diagram for explaining an example of superimposing and displaying a mark corresponding to a predetermined position.

FIG. 23 is a diagram for explaining an example of superimposing and displaying a mark corresponding to a predetermined position.

FIG. 24 is a diagram for explaining an example of superimposing and displaying a mark corresponding to a predetermined position on a head mounted display.

FIG. 25 is a diagram for explaining an example of display according to a line-of-sight position of a wearer.

FIG. 26 is a diagram for explaining an example of superimposing and displaying grids.

FIG. 27 is a diagram for explaining an example of displaying a parallax image as a partial image.

FIG. 28 is a diagram for explaining a modification of the display frame.

### MODE FOR CARRYING OUT THE INVENTION

Hereinafter, an embodiment according to the present technology will be described in the following order with reference to the accompanying drawings.
<1. Configuration of Image Processing System>
<2. Configuration of VR Conversion Device>
<3. Configuration of Plane Conversion Device>
<4. Mode>
<5. Change Display>
<6. Display Example>
<7. Modifications>
<8. Summary>
<9. Present Technology>

### 1. Configuration of Image Processing System

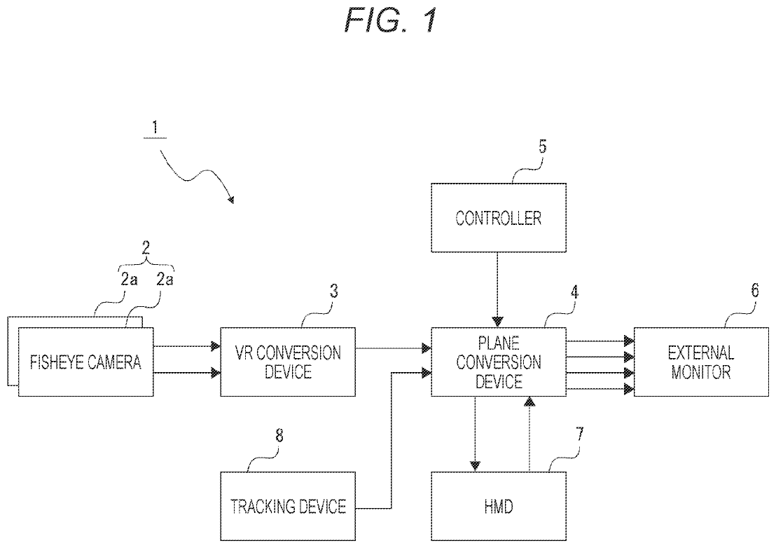

FIG. 1 is a diagram illustrating a configuration of an image processing system 1. As illustrated in FIG. 1, the image processing system 1 as an embodiment according to the present technology includes an omnidirectional camera device 2, a VR conversion device 3, a plane conversion device 4, a controller 5, an external monitor 6, a head mounted display (HMD) 7, and a tracking device 8.

In the omnidirectional camera device 2, two fisheye cameras 2a adopting a fisheye lens having an omnidirectional viewing angle of, for example, 220 degrees or more are arranged back to back, and the two fisheye cameras 2a can perform entire circumference capturing in a back-to-back manner.

In the omnidirectional camera device 2, two fisheye cameras 2a are each connected to the VR conversion device 3 by a cable (hereinafter, referred to as an SDI cable) of a serial digital interface (SDI) standard. The omnidirectional camera device 2 encodes the fisheye images captured by the two fisheye cameras 2a in a predetermined format, and outputs the encoded fisheye images as VR image signals to the VR conversion device 3 via the SDI cable. Note that the fisheye image (omnidirectional developed image) may be a moving image or a still image, but here, a case of being a moving image will be described as an example.

The VR conversion device 3 generates an omnidirectional VR image of 360 degrees by applying stitch processing to two fisheye images captured by the two fisheye cameras 2a of the omnidirectional camera device 2. The VR conversion device 3 is connected to the plane conversion device 4 in a wired or wireless manner, and outputs the omnidirectional developed image to the plane conversion device 4.

In the plane conversion device 4 as an image processing device, the controller 5, the external monitor 6, the head mounted display 7 (in the drawing, HMD is illustrated), and the tracking device 8 are connected in a wired or wireless manner. For example, the plane conversion device 4 is connected to the external monitor 6 via a high-definition multimedia interface (HDMI (registered trademark)) cable or an SDI cable.

The plane conversion device 4 cuts out all or part of the omnidirectional developed image input from the VR conversion device 3 on the basis of a user operation on the controller 5, performs predetermined signal processing on the cut out image, and outputs the image to the external monitor 6 as a partial image, thereby displaying the partial image on the external monitor 6. In addition, the plane conversion device 4 can also cause the head mounted display 7 to display a partial image. The plane conversion device 4 can generate different images for the external monitor 6 and the head mounted display 7.

The controller 5 includes a plurality of operators that receive a user operation, and outputs a signal corresponding to the operated operator to the plane conversion device 4. Note that the operator is a keyboard, a mouse, a button, a dial, a touch pad, a remote controller, or the like.

The external monitor 6 is a liquid crystal display, an organic electroluminescence (EL) display, or the like. The external monitor 6 displays a partial image and the like input from the plane conversion device 4.

The head mounted display 7 is a head mounted-type display that is used by being worn on the head of a wearer. As the display unit of the head mounted display 7, a liquid crystal display, an organic EL display, or the like is used. The head mounted display 7 displays a partial image input from the plane conversion device 4.

In addition to the display unit, the head mounted display 7 is provided with an eye sensor that detects the line-of-sight position of the wearer, a 6DoF gyro sensor that detects the movement and rotation of the head mounted display 7, that is, the posture of the head mounted display 7, and the like, and can output signals detected by these sensors to the plane conversion device 4.

The tracking device 8 is a device that tracks (follows) a position of a specific person or object. For example, the tracking device 8 causes a specific person to be tracked to hold the sensor and follows the position of the sensor, thereby tracking the position of the tracking target. Then, the tracking device 8 outputs information indicating the position of the tracking target to the plane conversion device 4.

In such an image processing system 1, the omnidirectional developed image captured by the omnidirectional camera device 2 and generated by the VR conversion device 3 is confirmed by the producer on a display unit 48 of the plane conversion device 4, the external monitor 6, the head mounted display 7, and the like in accordance with a user operation performed using the controller 5 or an input unit 47 of the plane conversion device 4. That is, the image processing system 1 is a system that generates an omnidirectional developed image and causes the producer to confirm the omnidirectional developed image.

Note that the confirmation here includes confirming how the generated omnidirectional developed image is displayed on the head mounted display 7 before providing the omnidirectional developed image as the input image and the like, and confirming for editing the omnidirectional developed image provided as the input image.

Furthermore, the producer includes various persons who provide content, and is, for example, a director, a camera operator, an engineer, a lighting staff, a manager of a performer, a makeup staff, a production instructor, a performer, or the like.

These producers confirm a region to be confirmed in the omnidirectional developed image according to each role.

### 2. Configuration of VR Conversion Device

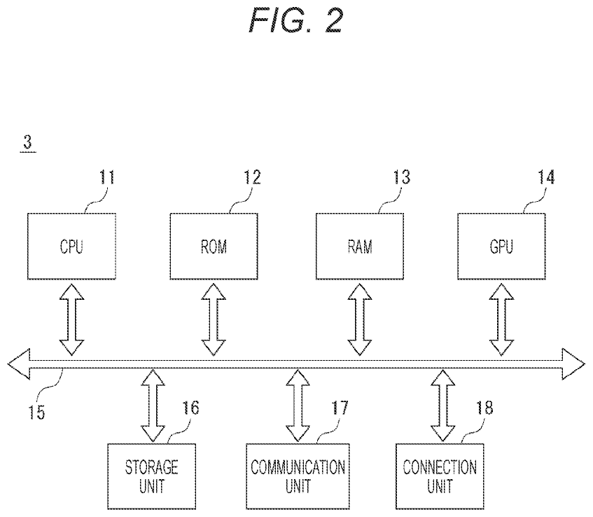

FIG. 2 is a diagram for explaining a configuration of the VR conversion device 3. As illustrated in FIG. 2, the VR conversion device 3 is a computer including a central processing unit (CPU) 11, a read only memory (ROM) 12, a random access memory (RAM) 13, and a graphics processing unit (GPU) 14.

The CPU 11 executes various processes according to a program stored in the ROM 12 or the storage unit 16. The RAM 13 also appropriately stores data and the like necessary for the CPU 11 to execute various processes.

The GPU 14 has a function of a geometry engine and a function of a rendering processor, performs image processing according to a drawing instruction from the CPU 11, and stores the image after the image processing in a frame buffer (not illustrated). Then, the GPU 14 outputs the image stored in the frame buffer to the plane conversion device 4 as a VR image (omnidirectional developed image).

The CPU 11, the ROM 12, the RAM 13, and the GPU 14 are connected to one another via a bus 15. A storage unit 16, a communication unit 17, and a connection unit 18 are also connected to the bus 15.

The storage unit 16 includes, for example, a storage medium such as a solid-state memory. The storage unit 16 can store, for example, various types of information described later. Furthermore, the storage unit 16 can also be used to store program data for the CPU 11 to execute various processes.

The communication unit 17 performs wired or wireless communication with another device (for example, the plane conversion device 4).

The connection unit 18 is, for example, a port for connecting another device such as a universal serial bus (USB) port, an IEEE 1394 port, an SDI port, an HDMI port, or the like. For example, the connection unit 18 is connected to two fisheye cameras 2a of the omnidirectional camera device 2 via two SDI cables.

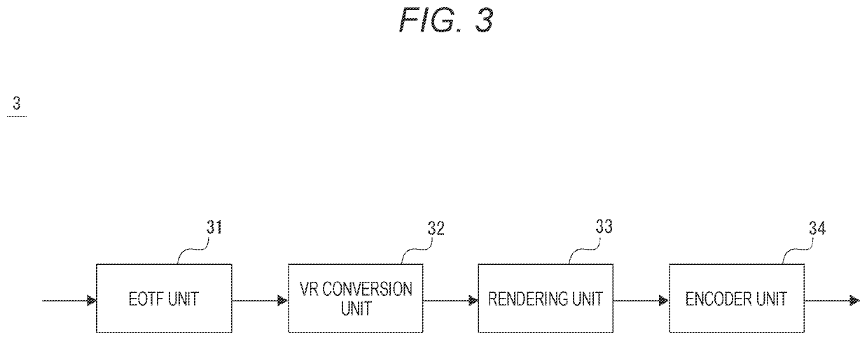

FIG. 3 is a diagram for explaining a functional configuration of the VR conversion device 3. As illustrated in FIG. 3, the VR conversion device 3 mainly functions as an electro-optical transfer function (EOTF) unit 31, a VR conversion unit 32, a rendering unit 33, and an encoder unit 34 by a CPU 11 and a GPU 15 which are arithmetic processing devices. Note that these functional units may function only by one of the CPU 11 and the GPU 14, or may function by cooperation of both the CPU 11 and the GPU 14. Furthermore, the VR conversion device 3 only needs to be able to generate an omnidirectional developed image from a fisheye image captured by the omnidirectional camera device 2, and the functional unit described here is an example.

The EOTF unit 31 performs LUT processing using a LUT (lookup table) and EOTF processing using an EOTF (electro-optical conversion characteristic) on each of the two fisheye images input from the omnidirectional camera device 2, thereby performing luminance correction, color gamut correction, and the like.

The VR conversion unit 32 performs distortion correction processing of correcting distortion due to the fisheye lens of the omnidirectional camera device 2 on each of the two fisheye images after the correction processing by the EOTF unit 31, and then generates an equirectangular image by projective transformation by equirectangular projection (ERP).

The rendering unit 33 synthesizes the two equirectangular images by performing the stitching processing on the two equirectangular images after the projective transformation. Then, the rendering unit 33 performs rendering processing such as color gamut conversion processing, optical-electro transfer function (OETF) processing using an OETF, or LUT processing on the synthesized image, thereby generating an omnidirectional developed image.

The encoder unit 34 converts the omnidirectional developed image after the rendering processing into a format such as HDMI or SDI, for example, and outputs the converted image data to the plane conversion device 4.

### 3. Configuration of Plane Conversion Device

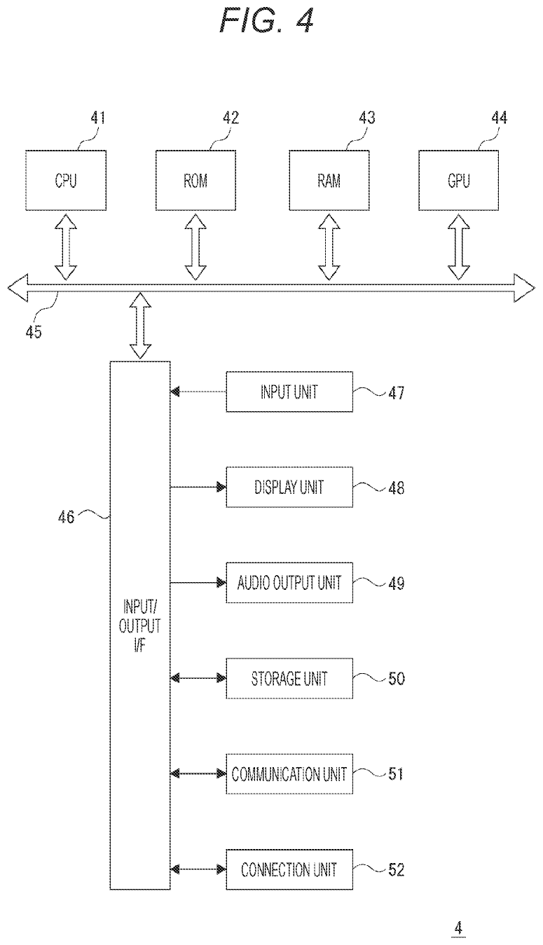

FIG. 4 is a diagram for explaining a configuration of the plane conversion device 4. As illustrated in FIG. 4, the plane conversion device 4 is a computer including a CPU 41, a ROM 42, a RAM 43, and a GPU 44.

The CPU 41 executes various processes according to a program stored in the ROM 42 or the storage unit 50. The RAM 43 appropriately stores data and the like necessary for the CPU 41 to execute various processes.

The GPU 44 has a function of a geometry engine and a function of a rendering processor, performs image processing according to a drawing instruction from the CPU 11, and stores the image after the image processing in a frame buffer (not illustrated). Then, the GPU 44 outputs the image stored in the frame buffer to the display unit 48, the external monitor 6, or the head mounted display 7 for display.

The CPU 41, the ROM 42, the RAM 43, and the GPU 44 are connected to one another via a bus 45. An input/output interface 46 is also connected to the bus 45.

The input unit 47 for the user to perform an input operation, the display unit 48 including a liquid crystal display, an organic EL display, or the like, an audio output unit 49 including a speaker or the like, a storage unit 50, a communication unit 51, a connection unit 52, and the like can be connected to the input/output interface 46.

The input unit 47 means an input device used by a user who uses the plane conversion device 4. For example, the input unit 47 may be various operators and operation devices such as a keyboard, a mouse, a button, a dial, a touch pad, and a remote controller. A user operation is detected by the input unit 47, and a signal corresponding to the input operation is input to the CPU 41.

The display unit 48 displays various images on the basis of an instruction from the CPU 41 or the GPU 44. Furthermore, the display unit 48 can also display various operation menus, icons, messages, and the like, that is, display as a graphical user interface (GUI), on the basis of an instruction from the CPU 41 or the GPU 44.

The storage unit 50 includes, for example, a storage medium such as a solid-state memory. The storage unit 50 can store, for example, various types of information described later. Furthermore, the storage unit 50 can also be used to store program data for the CPU 41 to execute various processes.

The communication unit 51 performs wired or wireless communication with another device (for example, the VR conversion device 3).

The connection unit 52 is, for example, a port for connecting another device such as a universal serial bus (USB) port, an IEEE 1394 port, an SDI port, an HDMI port, or the like. For example, the connection unit 52 is connected to the external monitor 6 via four SDI cables and one HDMI cable. Furthermore, the connection unit 52 is connected to the head mounted display 7 via one HDMI cable. As a result, various images are output from the connection unit 52, and various images are displayed on the display unit of the external monitor 6 or the head mounted display 7. That is, the connection unit 52 functions as an output unit that outputs signals of various images.

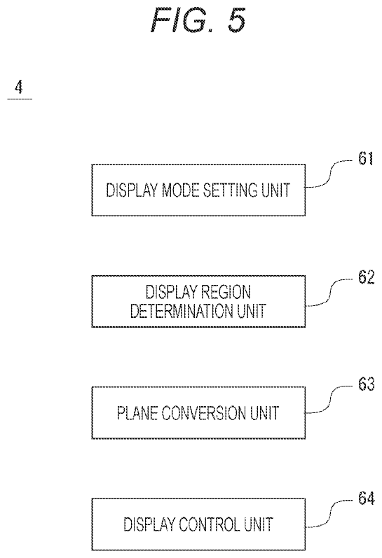

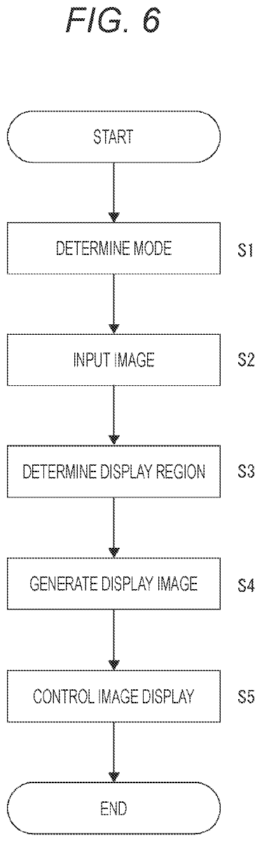

FIG. 5 is a diagram for explaining a functional configuration of the plane conversion device 4. FIG. 6 is a flowchart illustrating an outline of a flow of processing in the plane conversion device 4.

As illustrated in FIG. 5, the plane conversion device 4 mainly functions as a display mode setting unit 61, a display region determination unit 62, a plane conversion unit 63, and a display control unit 64 by the CPU 41 and the GPU 44 which are arithmetic processing devices. Note that these functional units may function only by one of the CPU 41 and the GPU 44, or may function by cooperation of both the CPU 41 and the GPU 44.

As will be described in detail later, the plane conversion device 4 is provided with a plurality of modes in which all or a part of the omnidirectional developed image is cut out and displayed on the external monitor 6 as a partial image. As illustrated in FIG. 6, in step S1, the display mode setting unit 61 determines one mode selected by the user from a plurality of modes.

Then, when the image data of the omnidirectional developed image is input in step S2, the display region determination unit 62 determines a region of a partial image to be displayed on the external monitor 6 or the head mounted display 7 from the omnidirectional developed image as a display region in step S3 on the basis of the selected mode, a user operation on the controller 5 or the input unit 47, or the like.

Subsequently, in step S4, the plane conversion unit 63 cuts out the image portion of the display region determined by the display region determination unit 62 from the omnidirectional developed image, and performs distortion correction processing (plane projection correction processing) or the like to correct distortion of the cut out image portion, thereby generating a partial image that is a planar image.

In step S5, the display control unit 64 controls image display on the external monitor 6, the head mounted display 7, and the display unit 48. For example, the display control unit 64 causes the external monitor 6 and the head mounted display 7 to display the partial image generated by the plane conversion unit 63.

Hereinafter, specific processing of the display mode setting unit 61, the display region determination unit 62, the plane conversion unit 63, and the display control unit 64 will be described. Note that, hereinafter, a person who visually recognizes (confirms) the external monitor 6 and the display unit 48 is referred to as a user, and a person wearing the head mounted display 7 is referred to as a wearer.

### 4. Mode

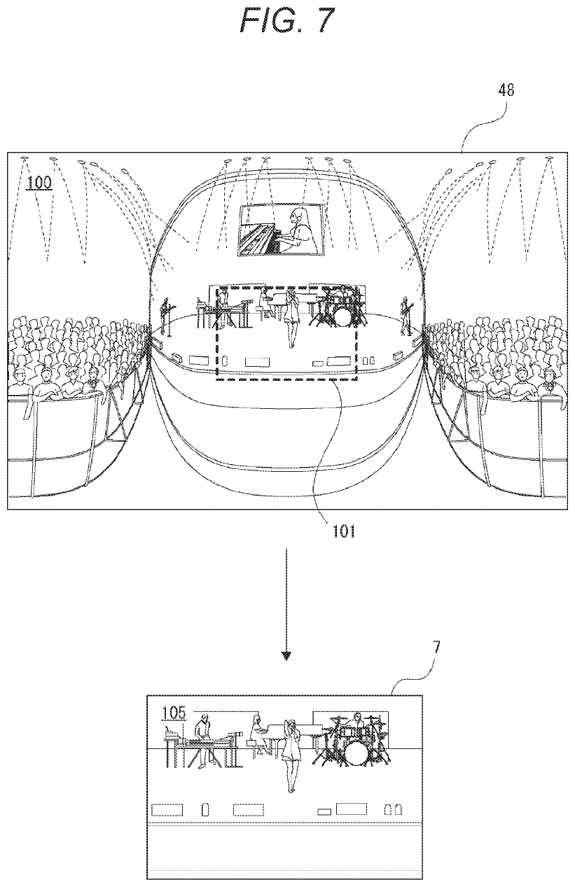

FIG. 7 is a diagram for explaining images displayed on the display unit 48 and the head mounted display 7. First, a case where an omnidirectional developed image generated from a fisheye image captured by the omnidirectional camera device 2 is displayed on the head mounted display 7 will be described.

As illustrated in FIG. 7, in the plane conversion device 4, the omnidirectional developed image 100 captured by the omnidirectional camera device 2 and generated by the VR conversion device 3 is displayed on the display unit 48, and a part of the omnidirectional developed image 100 is displayed on the head mounted display 7 as a partial image (here, the HMD partial image 105) on the basis of the posture of the head mounted display 7.

Specifically, the display region determination unit 62 determines the display region 101 according to the posture of the wearer from the omnidirectional developed image 100 on the basis of the posture information transmitted from the head mounted display 7. Then, the plane conversion unit 63 cuts out the image portion of the determined display region 101 from the omnidirectional developed image 100, and performs distortion correction processing on the cut out image to generate the HMD partial image 105. Then, the display control unit 64 outputs the generated image signal of the HMD partial image 105 to the head mounted display 7 to display the HMD partial image 105 on the display unit of the head mounted display 7.

Here, since only a part of the omnidirectional developed image 100 is displayed on the head mounted display 7, it is difficult for the producer to confirm the entire omnidirectional developed image 100 using the head mounted display 7. Furthermore, it is also possible to display and confirm the omnidirectional developed image 100 on the external monitor 6 or the display unit 48, but in that case, since the omnidirectional developed image 100 is distorted at a portion other than the center, it is difficult to confirm all the regions using the omnidirectional developed image 100.

Therefore, the plane conversion device 4 is provided with a plurality of modes, and displays all or a part of the omnidirectional developed image 100 on the external monitor 6 and the display unit 48 in the mode selected by the user. In the plane conversion device 4, as an example, six modes of a first display mode to a sixth display mode are provided. Note that the images displayed on the display unit 48 are commonly set as the omnidirectional developed image 100 from the first display mode to the sixth display mode. In addition, in any of the first display mode to the sixth display mode, a part of the omnidirectional developed image 100 can be displayed as the HMD partial image 105 on the head mounted display 7.

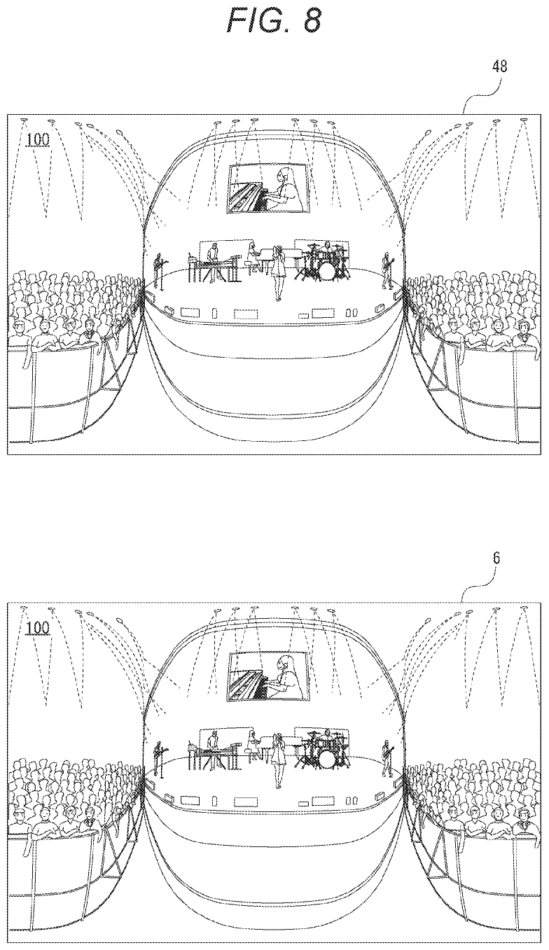

FIG. 8 is a diagram for explaining a first display mode. As illustrated in FIG. 8, the first display mode is a mode in which the entire omnidirectional developed image 100 is displayed on the display unit 48 and the entire omnidirectional developed image 100 is also mirror-displayed on the external monitor 6.

In a case where the display mode setting unit 61 sets the first display mode in accordance with a user operation on the controller 5, the display control unit 64 outputs the image signal of the omnidirectional developed image 100 to the external monitor 6 to cause the external monitor 6 to display the omnidirectional developed image 100.

In the first display mode, for example, by displaying the omnidirectional developed image 100 on the external monitor 6 having a larger number of pixels and a larger screen than the display unit 48, it is possible to allow the user to confirm the omnidirectional developed image 100 as a whole.

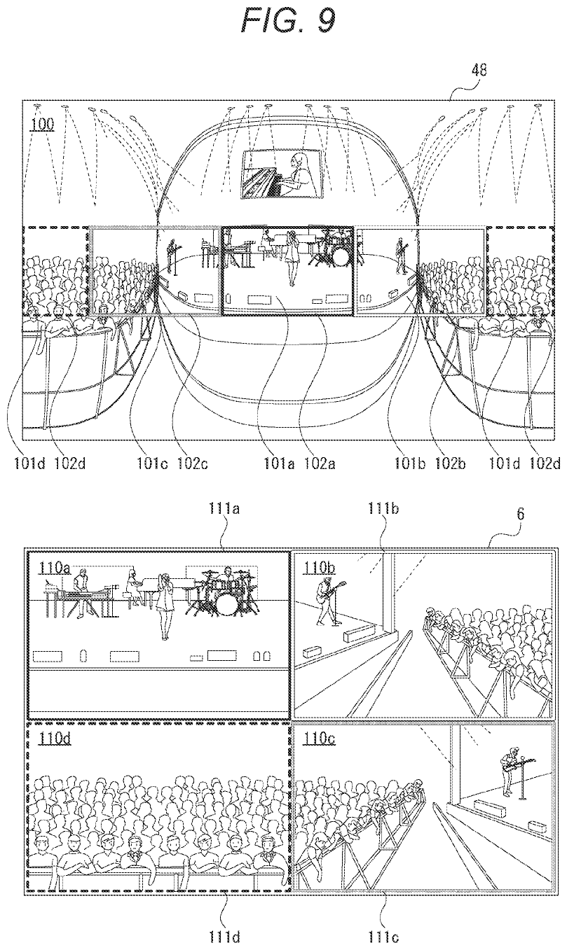

FIG. 9 is a diagram for explaining a second display mode. As illustrated in FIG. 9, the second display mode is a mode in which the entire omnidirectional developed image 100 is displayed on the display unit 48, and four partial images 110 (110a to 110d) as a part of the omnidirectional developed image 100 are displayed side by side on the external monitor 6.

In a case where the display mode setting unit 61 sets the second display mode in accordance with a user operation on the controller 5, the display region determination unit 62 determines four display regions 101 (101a to 101d) from the omnidirectional developed image 100.

In the second display mode, for example, the angle of view of the display region 101 is preset to 60 degrees in the vertical direction and 90 degrees in the horizontal direction. Furthermore, the display region determination unit 62 determines a display region 101a centered on a preset center position in the omnidirectional developed image 100, a display region 101b adjacent to the right side of the display region 101a, a display region 101c adjacent to the left side of the display region 101a, and a display region 101d adjacent to the display region 101b and the display region 101c.

Note that the display region 101d is a region diametrically opposite (180 degrees opposite) to the display region 101a in the horizontal direction of the omnidirectional developed image 100. Furthermore, the center position of the omnidirectional developed image 100 may be the center of the fisheye image captured by one fisheye camera 2a of the omnidirectional camera device 2, or may be designated by the user from the omnidirectional developed image 100.

In addition, the display ranges (angles of view) of the display regions 101a to 101d and the set positions can be changed as appropriate. For example, the display regions 101a to 101d may be determined in accordance with the resolution (the number of pixels) of the display unit of the head mounted display 7, or may be set in accordance with the display angle of view of the display unit of the head mounted display 7. In addition, the display regions 101a to 101d may be determined as display regions designated by the user.

The plane conversion unit 63 cuts out image portions of the determined display regions 101a to 101d from the omnidirectional developed image 100, and performs distortion correction processing on the cut out image portions to generate partial images 110a to 110d. Then, the display control unit 64 outputs the image signals of the partial images 110a to 110d to the external monitor 6 to display the partial images 110a to 110d of the display regions 101a to 101d side by side on the external monitor 6. At this time, the plane conversion device 4 may separately output the image signals of the partial images 110a to 110d to the external monitor 6 by four SDI cables, or may combine the partial images 110a to 110d into one image and output the combined image to the external monitor 6 by one SDI cable.

In addition, the display control unit 64 superimposes and displays display frames 102a to 102d indicating the display regions 101a to 101d on the omnidirectional developed image 100 displayed on the display unit 48 in different display modes. In addition, the display control unit 64 superimposes and displays display frames 111a to 111d in the same display mode as the display frames 102a to 102d of the corresponding display regions 101a to 101d on the partial images 110a to 110d displayed on the external monitor 6.

Here, the different display modes are display modes in which it is possible to identify that the users are different from each other, such as changing the color of the frame, changing the width of the frame, or displaying with different line types.

As described above, by displaying the display frames 102a to 102d and 111a to 111d on the display unit 48 and the external monitor 6 in the same display mode, the user can easily and instantly grasp the correspondence relationship between the display region 101 in the omnidirectional developed image 100 and the partial image 110 displayed on the external monitor 6.

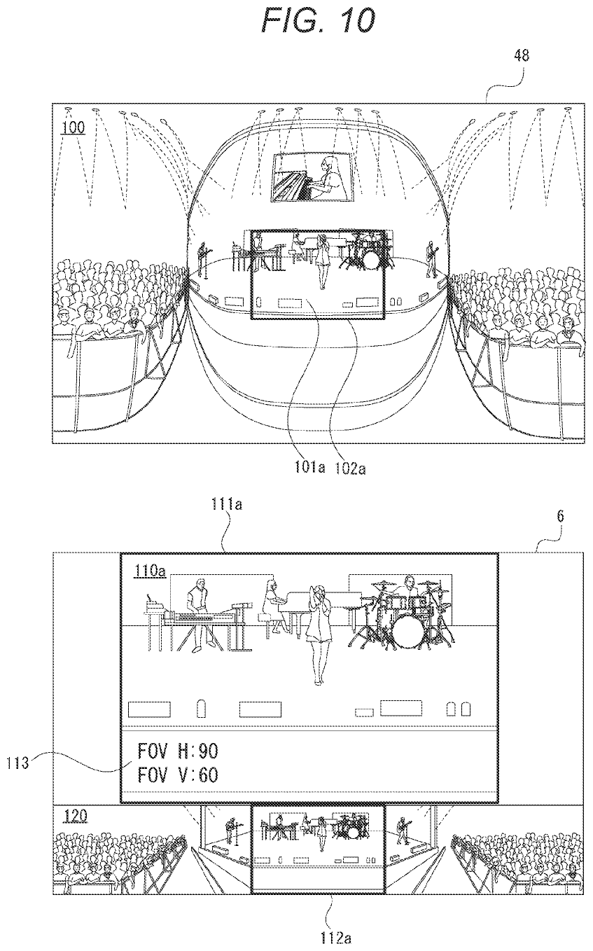

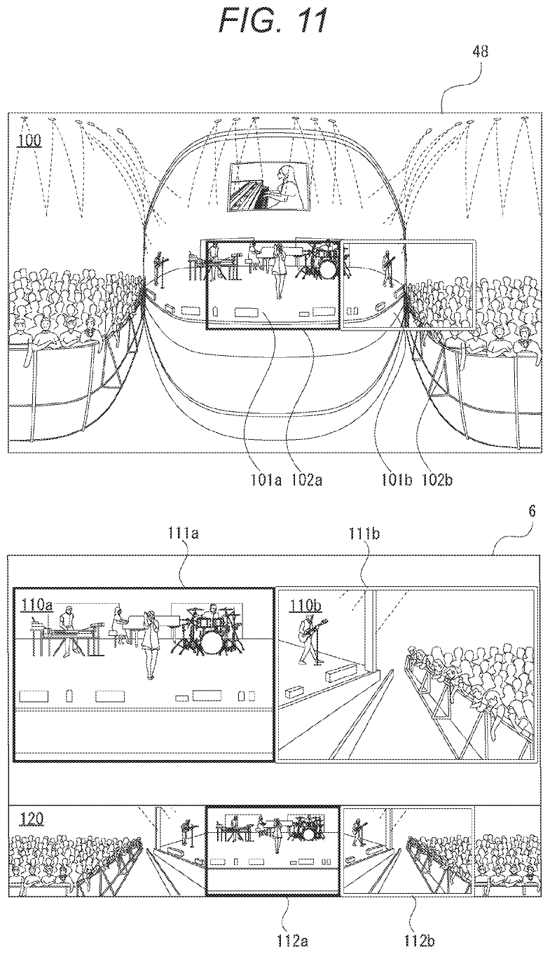

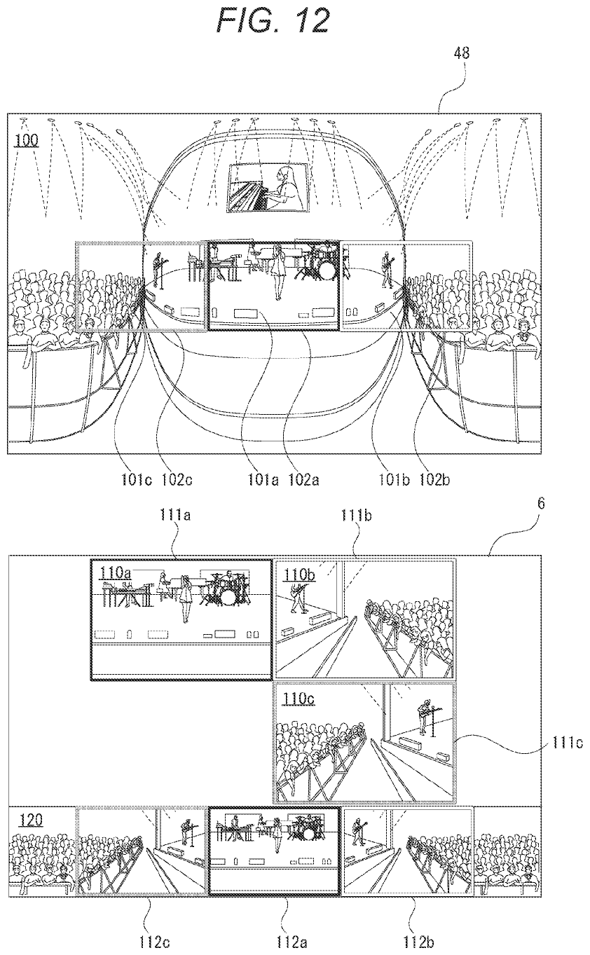

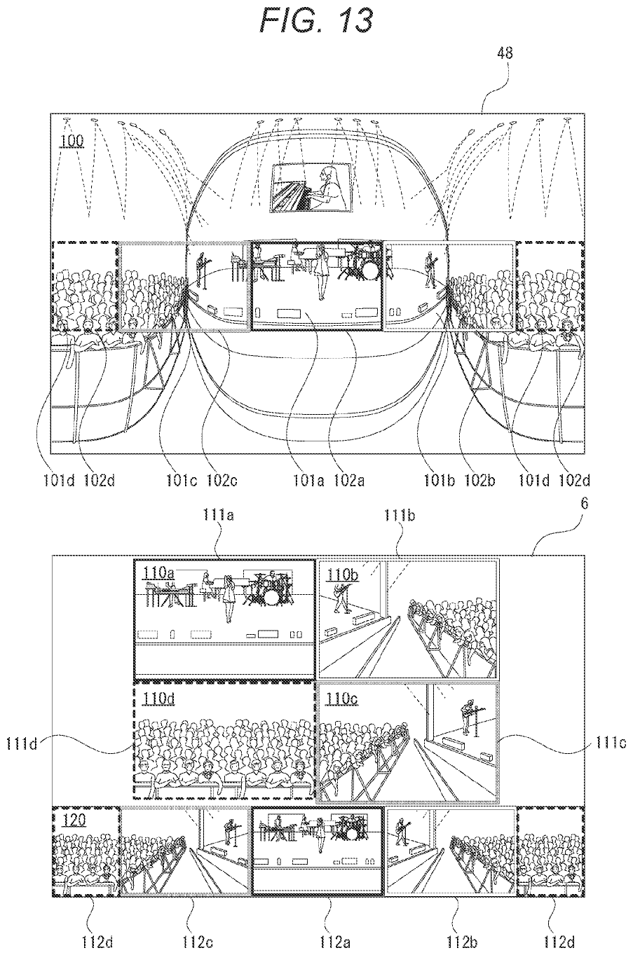

FIGS. 10 to 13 are diagrams for explaining the third display mode to the sixth display mode. As illustrated in FIGS. 10 to 13, the third display mode to the sixth display mode are modes in which the entire omnidirectional developed image 100 is displayed on the display unit 48, one or a plurality of partial images 110 obtained by cutting out a part of the omnidirectional developed image 100 is displayed on the external monitor 6, and a panorama image 120 having an aspect ratio horizontally longer than the display region 101 is displayed below the external monitor 6.

In a case where the display mode setting unit 61 sets any of the third display mode to the sixth display mode according to a user operation to the controller 5, the display region determination unit 62 sets, from the omnidirectional developed image 100, a panorama display region having a preset center position in the omnidirectional developed image 100 as a center and an angle of view of, for example, 60 degrees in the vertical direction and 360 degrees in the horizontal direction.

Furthermore, the display region determination unit 62 determines one display region 101 (display region 101a) from the omnidirectional developed image 100 in the case of the third display mode, and determines two display regions 101 (display regions 101a and 101b) from the omnidirectional developed image 100 in the case of the fourth display mode. Furthermore, the display region determination unit 62 determines three display regions (display regions 101a to 101c) from the omnidirectional developed image 100 in the case of the fifth display mode, and determines four display regions (display regions 101a to 101d) from the omnidirectional developed image 100 in the case of the sixth display mode. The display regions 101a to 10d are determined similarly to the second display mode.

The plane conversion unit 63 cuts out one or a plurality of display regions 101a to 101d determined according to the mode and an image portion of the panorama display region from the omnidirectional developed image 100, and performs distortion correction processing on the cut out image portion. As a result, the plane conversion unit 63 generates the partial image (one or a plurality of 110a to 110d) and the panorama image 120.

The display control unit 64 outputs the partial image (one or a plurality of 110a to 110d) determined according to the mode and the image signal of the panorama image 120 to the external monitor 6, so that the partial image 110 generated according to the mode is displayed side by side on the upper portion and the panorama image 120 is displayed on the lower portion of the external monitor 6.

Furthermore, the display control unit 64 superimposes and displays a display frame 102 (one or a plurality of 102a to 102d) indicating the display region 101 (one or a plurality of the display regions 101a to 101d) according to the mode on the omnidirectional developed image 100 displayed on the display unit 48.

Further, the display control unit 64 superimposes and displays the display frames 111 (one or a plurality of 111a to 111d) of the same display mode as the display frames 102a to 102d of the corresponding display regions 101a to 101d on the partial image 110 (one or a plurality of the partial images 110a to 100d) displayed on the external monitor 6.

Further, the display control unit 64 superimposes and displays the display frames 112 (one or a plurality of the display frames 112a to 112d) in the same display mode as the display frames 102a to 102d of the corresponding display regions 101a to 101d on the panorama image 120 displayed on the external monitor 6.

As described above, in the third display mode to the sixth display mode, the number of partial images 110 designated by the user is displayed on the external monitor 6, and the panorama image 120 is displayed on the external monitor 6, so that it is possible to easily and instantly grasp the correspondence relationship between the omnidirectional developed image 100 and the partial image 110 by mainly confirming only the external monitor 6.

Furthermore, as illustrated in FIG. 10, the display control unit 64 may superimpose and display the view angle information 113 indicating the angle of view of the partial image 110 on the partial image 110. In the example of FIG. 10, “field of view (FOV) H: 90” indicates that the angle of view in the horizontal direction is 90 degrees, and “FOV V: 60” indicates that the angle of view in the vertical direction is 60 degrees. Note that the view angle information 113 can be displayed on the partial image 110 in all the modes.

### 5. Change Display

In the plane conversion device 4, the position and size of the display region 101 in the omnidirectional developed image 100 can be changed according to a user operation via the controller 5. Specifically, the display region 101 can be moved in the up-down direction (vertical direction) and the left-right direction (horizontal direction), and can be enlarged and reduced. Note that these changes can be made in any of the second display mode to the sixth display mode.

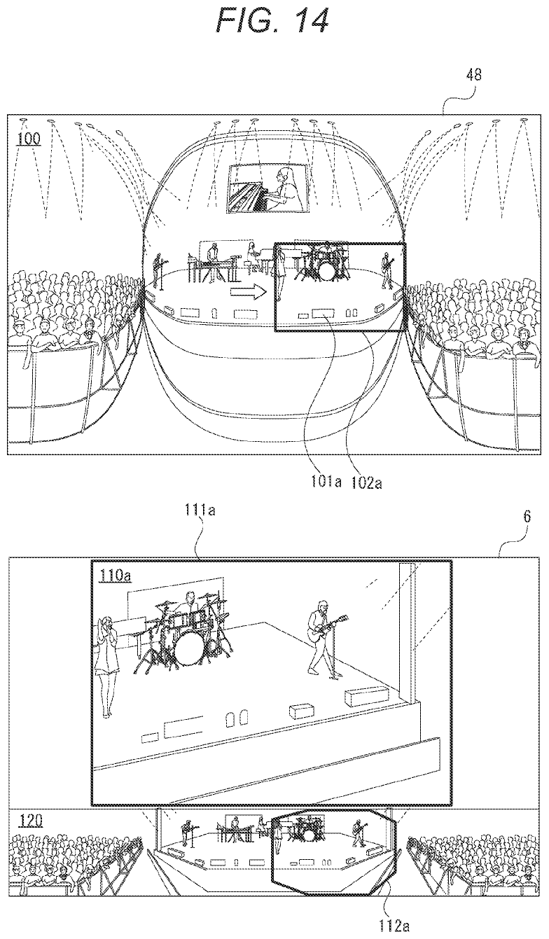

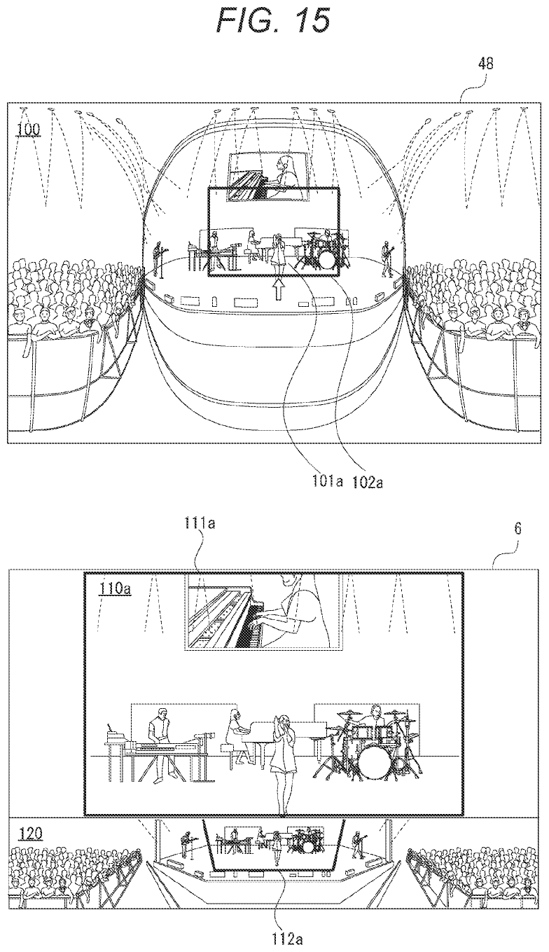

FIG. 14 is a diagram for explaining a case where the display region 101 is moved in the right direction. FIG. 15 is a diagram for explaining a case where the display region 101 is moved in the upward direction. Note that FIGS. 14 and 15 illustrate the case of the third display mode.

The controller 5 is provided with an operator (button) to which an upward movement, a downward movement, a leftward movement, and a rightward movement are assigned. Then, when these operators provided in the controller 5 are operated, the display region determination unit 62 moves the display region 101 according to the operation of the operators. For example, as illustrated in FIG. 14, when an operator to which rightward movement is allocated is operated, the display region determination unit 62 moves the display region 101a rightward.

The plane conversion unit 63 cuts out an image portion of the moved display region 101a from the omnidirectional developed image 100, and performs distortion correction processing on the cut out image portion to generate a partial image 110a.

Then, the display control unit 64 outputs the generated image signal of the partial image 110a to the external monitor 6 to display the partial image 110a of the moved display region 101a on the external monitor 6.

In addition, the display control unit 64 moves and displays the display frame 102a of the omnidirectional developed image 100 displayed on the display unit 48 and the display frame 112a of the panorama image 120 displayed on the external monitor 6. At this time, in order to easily confirm that the rightward movement is performed, the display control unit 64 displays the display frame 112a such that the display frame is octagonal as a whole and the right side is larger than the left side.

In addition, when the operator to which the upward movement is allocated is operated, the display region determination unit 62 moves the display region 101a in the upward direction as illustrated in FIG. 15.

The plane conversion unit 63 cuts out an image portion of the moved display region 101a from the omnidirectional developed image 100, and performs distortion correction processing on the cut out image portion to generate a partial image 110a.

Then, the display control unit 64 outputs the generated image signal of the partial image 110a to the external monitor 6 to display the partial image 110a of the moved display region 101a on the external monitor 6.

In addition, the display control unit 64 moves and displays the display frame 102a of the omnidirectional developed image 100 displayed on the display unit 48 and the display frame 112a of the panorama image 120 displayed on the external monitor 6. At this time, in order to easily confirm that the upward movement is performed, the display control unit 64 displays, for example, the lower side of the display frame 112a of the panorama image 120 in a substantially trapezoidal shape contracted in the left-right direction.

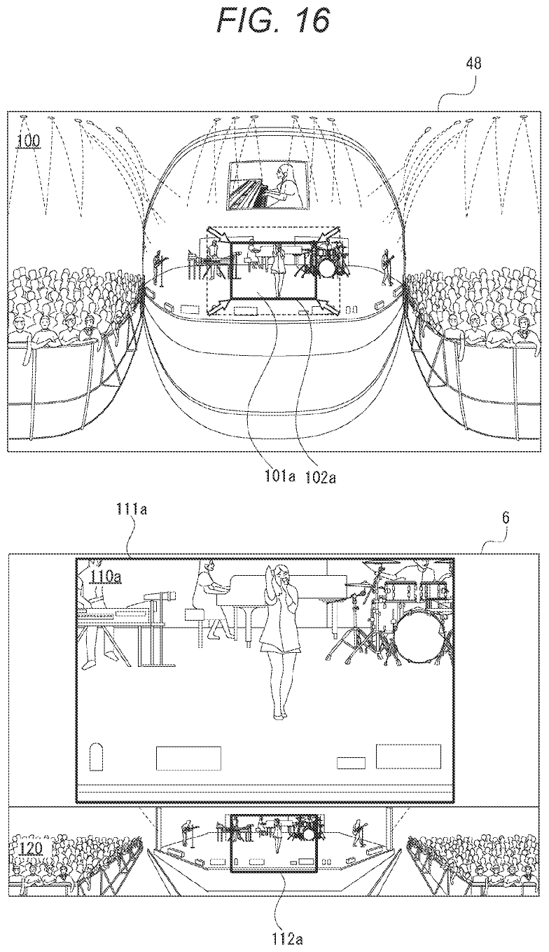

FIG. 16 is a diagram for explaining a case where the display region 101 is enlarged. Note that FIG. 16 illustrates the case of the third display mode.

The controller 5 is provided with operators (buttons) to which enlargement display and reduction display are allocated. Then, when these operators provided in the controller 5 are operated, the display region determination unit 62 enlarges or reduces the display region 101 according to the operation of the operator.

For example, when an operator to which enlargement display is assigned is operated, the display region determination unit 62 reduces the display region 101a in order to enlarge and display the partial image 110a as illustrated in FIG. 16.

The plane conversion unit 63 cuts out an image portion of the reduced display region 101a from the omnidirectional developed image 100, and performs distortion correction processing on the cut out image portion to generate a partial image 110a.

Then, the display control unit 64 outputs the generated image signal of the partial image 110a to the external monitor 6 to display the enlarged partial image 110a on the external monitor 6.

In addition, the display control unit 64 reduces and displays the display frame 102a of the omnidirectional developed image 100 displayed on the display unit 48 and the display frame 112a of the panorama image 120 displayed on the external monitor 6.

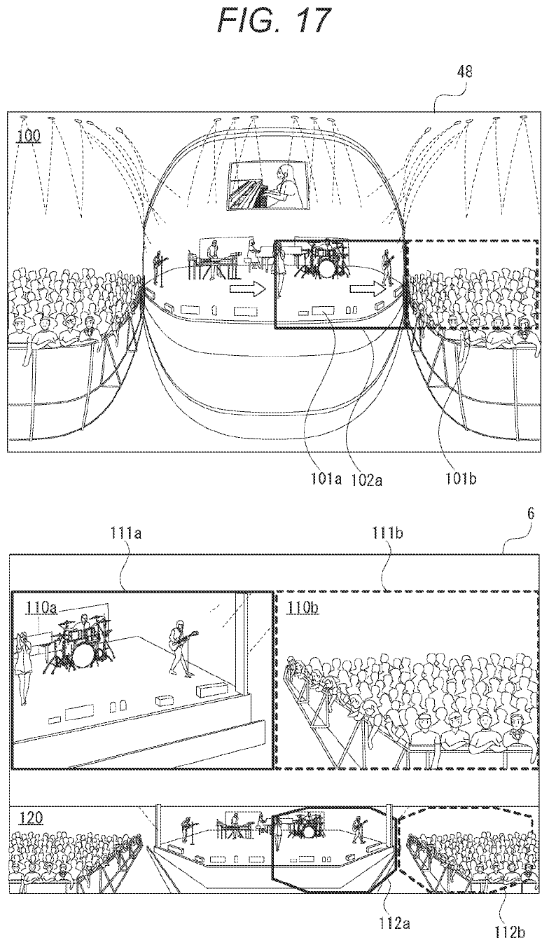

FIG. 17 is a diagram for explaining a case where the plurality of display regions 101 is moved in the right direction. Note that FIG. 17 illustrates the case of the fourth display mode.

The controller 5 is provided with an operator (button) for selecting the plurality of display regions 101. For example, after the two display regions 101a and 101b are selected, when an operator assigned to rightward movement is operated, the display region determination unit 62 moves the selected two display regions 101a and 101b in conjunction with each other in the right direction as illustrated in FIG. 17.

The plane conversion unit 63 cuts out image portions of the two moved display regions 101a and 101b from the omnidirectional developed image 100, and performs distortion correction processing on the cut out image portions to generate partial images 110a and 110b.

Then, the display control unit 64 transmits the generated image signals of the partial images 110a and 110b to the external monitor 6 to display the two moved partial images 110a and 110b on the external monitor 6.

In addition, the display control unit 64 moves and displays the display frames 102a and 102b of the omnidirectional developed image 100 displayed on the display unit 48 and the display frames 112a and 112b of the panorama image 120 displayed on the external monitor 6, similarly to the example of FIG. 14.

Note that, for example, when an operator to which enlargement or reduction is assigned is operated after the plurality of display regions 101 is selected, the display region determination unit 62 can also enlarge or reduce the plurality of selected display regions 101 in conjunction with each other.

### 6. Display Example

Next, a display example of the partial image 110 displayed on the external monitor 6 will be described. The display example described here can be displayed in any of the first display mode to the sixth display mode described above. Furthermore, a plurality of display examples may be combined.

### 6-1. Display Example 1

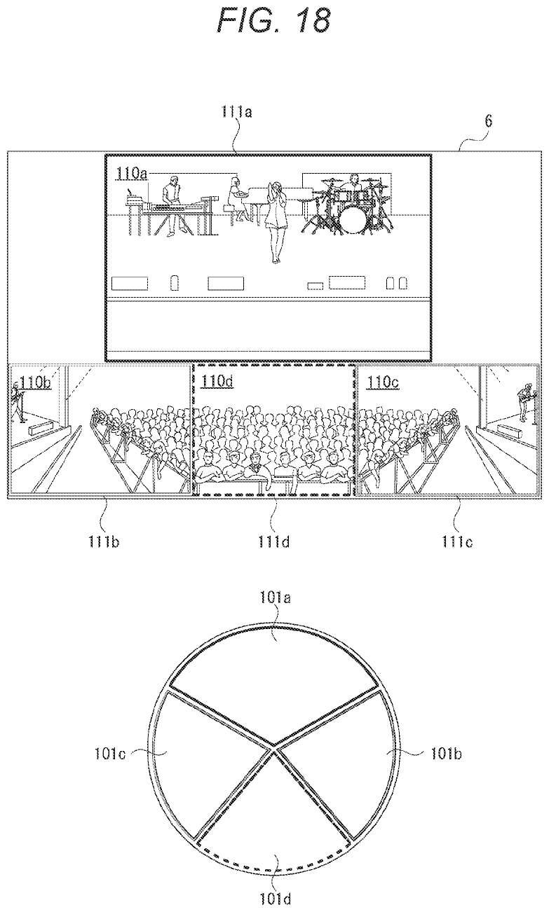

FIG. 18 is a diagram for explaining a relationship with the partial image 110 of the head mounted display 7. FIG. 18 illustrates the case of the second display mode. Furthermore, in the lower part of FIG. 18, the display regions 101a to 101d are illustrated as viewed from above.

In Display Example 1, one partial image 110a of the four partial images 110a to 110d is the same as the HMD partial image 105 displayed on the head mounted display 7.

Specifically, when information indicating the posture is input from the head mounted display 7, the display region determination unit 62 determines the display region 101 (display region 101a) according to the posture. The plane conversion unit 63 cuts out an image portion of the display region 101 from the omnidirectional developed image 100, and performs distortion correction processing on the cut out image portion to generate a partial image (HMD partial image 105 or partial image 110a). Then, the display control unit 64 outputs the image signal of the partial image to the external monitor 6 and the head mounted display 7 to display the partial image 110a on the external monitor 6 and display the HMD partial image 105 on the head mounted display 7.

As a result, the plane conversion device 4 can cause the user to confirm the HMD partial image 105 confirmed by the wearer on the head mounted display 7 as the partial image 110a on the external monitor 6.

In addition, as illustrated in the lower part of FIG. 18, the display region determination unit 62 determines three display regions 101b to 101d that have the same angle of view in the vertical direction as the display region 101a according to the posture of the head mounted display 7 and have the angle of view obtained by equally dividing the range excluding the angle of view of the display region 101a in the horizontal direction by the number of other display regions (three) in the omnidirectional developed image 100.

The plane conversion unit 63 cuts out image portions of the display regions 101b to 101d from the omnidirectional developed image 100, and performs distortion correction processing on the cut out image portions to generate partial images 110b to 110d. Then, as illustrated in the upper part of FIG. 18, the display control unit 64 outputs the image signals of the partial images 110b to 110d to the external monitor 6 to display the partial images 110b to 110d on the external monitor 6.

In this manner, the display region determination unit 62 determines the display region 101a to be displayed on the head mounted display 7 in the omnidirectional developed image 100 and the display regions 101b to 101d different from the display region 101a in the omnidirectional developed image 100. Then, the display control unit 64 displays the partial images 110a to 110d of the display region 101a and the display regions 101b to 101d on the external monitor 6.

As a result, the HMD partial image 105 confirmed by the wearer on the head mounted display 7 is set as the partial image 110a, and the user can confirm the other partial images 110b to 110d. That is, the plane conversion device 4 can cause the user to confirm a region that is difficult for the wearer of the head mounted display 7 to confirm in the omnidirectional developed image 100.

In addition, the display control unit 64 superimposes and displays the display frames 111a to 111d of the display regions 101a to 101d displayed on the external monitor 6.

### 6-2. Display Example 2

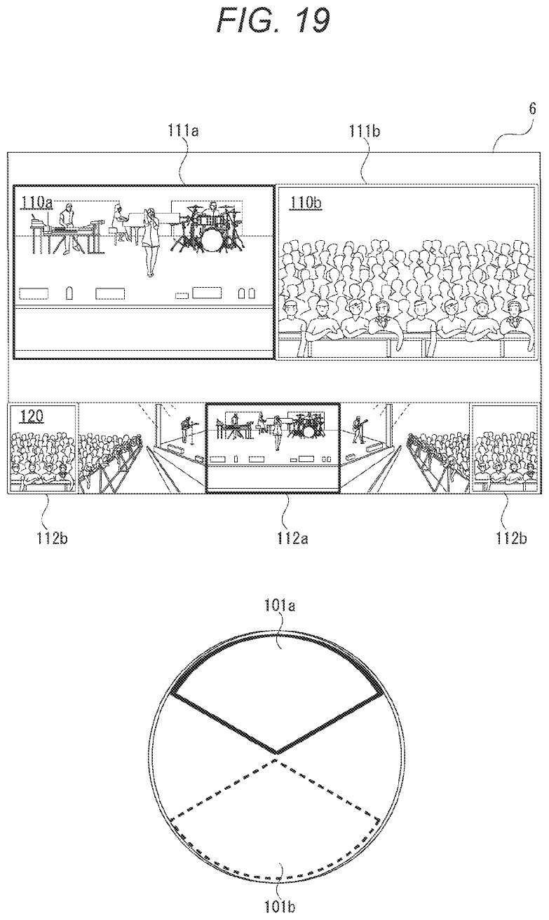

FIG. 19 is a diagram for explaining a relationship with the HMD partial image 105 of the head mounted display 7. FIG. 19 illustrates the case of the fourth display mode. Furthermore, in the lower part of FIG. 19, the display regions 101a and 101b are illustrated as viewed from above.

In Display Example 2, one partial image 110a of the two partial images 110a and 110b is the same as the HMD partial image 105 displayed on the head mounted display 7.

Specifically, when information indicating the posture is input from the head mounted display 7, the display region determination unit 62 determines the display region 101 (display region 101a) according to the posture. The plane conversion unit 63 cuts out an image portion of the display region 101a from the omnidirectional developed image 100, and performs distortion correction processing on the cut out image portion to generate a partial image (HMD partial image 105, partial image 110a). Then, the display control unit 64 outputs the image signal of the partial image to the external monitor 6 and the head mounted display 7 to display the partial image 110a on the external monitor 6 and display the HMD partial image 105 on the head mounted display 7.

As a result, the user can confirm the HMD partial image 105 confirmed by the wearer on the head mounted display 7 as the partial image 110a.

Furthermore, as illustrated in the lower part of FIG. 19, the display region determination unit 62 determines a display region 101b having the same angle of view in the vertical direction as the display region 101a according to the posture of the head mounted display 7 and diametrically opposite (opposite by 180 degrees) in the horizontal direction in the omnidirectional developed image 100.

The plane conversion unit 63 cuts out an image portion of the display region 101b from the omnidirectional developed image 100, and performs distortion correction processing on the cut out image portion to generate a partial image 110b. Then, as illustrated in the upper part of FIG. 19, the display control unit 64 outputs the image signal of the partial image 110b to the external monitor 6 to display the partial image 110b on the external monitor 6.

This allows the user to confirm the partial image 110b diametrically opposite to the partial image 110a confirmed by the wearer on the head mounted display 7. That is, the plane conversion device 4 can cause the user to confirm a diametrically opposite region that is most difficult for the wearer of the head mounted display 7 to confirm in the omnidirectional developed image 100.

In addition, the display control unit 64 superimposes and displays the display frames 111a to 111d of the display regions 101a to 101d displayed on the external monitor 6, and superimposes and displays the display frames 112a and 112b on the panorama image 120.

### 6-3. Display Example 3

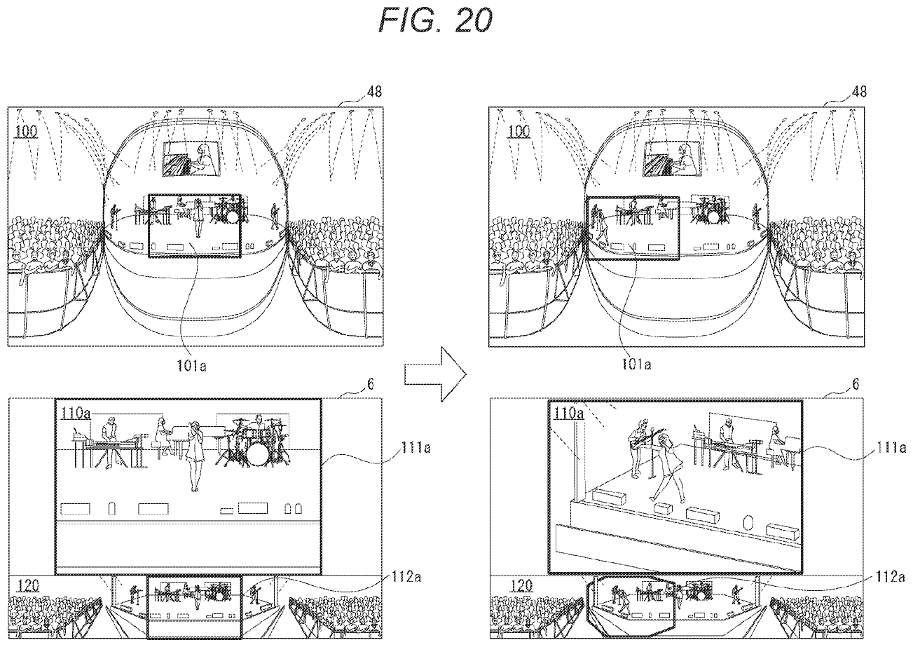

FIG. 20 is a diagram for explaining an example of the tracking display. Note that FIG. 20 illustrates the case of the third display mode.

In Display Example 3, display control is performed such that the tracking device 8 displays the tracking target being tracked on the partial image 110.

For example, it is assumed that the tracking device 8 follows a tracking target such as a vocal in a concert. Then, it is assumed that the tracking target moves leftward as illustrated from the left side of FIG. 20 to the right side of FIG. 20. In such a case, the display region determination unit 62 determines the display region 101a including the position of the tracking target (set to the center) on the basis of the information indicating the position of the tracking target from the tracking device 8 every time the omnidirectional developed image 100 is input from the VR conversion device 3 (for each frame).

The plane conversion unit 63 cuts out an image portion of the display region 101a from the omnidirectional developed image 100, and performs distortion correction processing on the cut out image portion to generate a partial image 110a. Then, the display control unit 64 outputs the image signal of the partial image 110a to the external monitor 6 to display the partial image 110a in which the tracking target is displayed at the center on the external monitor 6.

In this manner, by displaying the tracking target on the partial image 110a following the tracking target, the tracking target can be confirmed by the user as needed.

### 6-4. Display Example 4

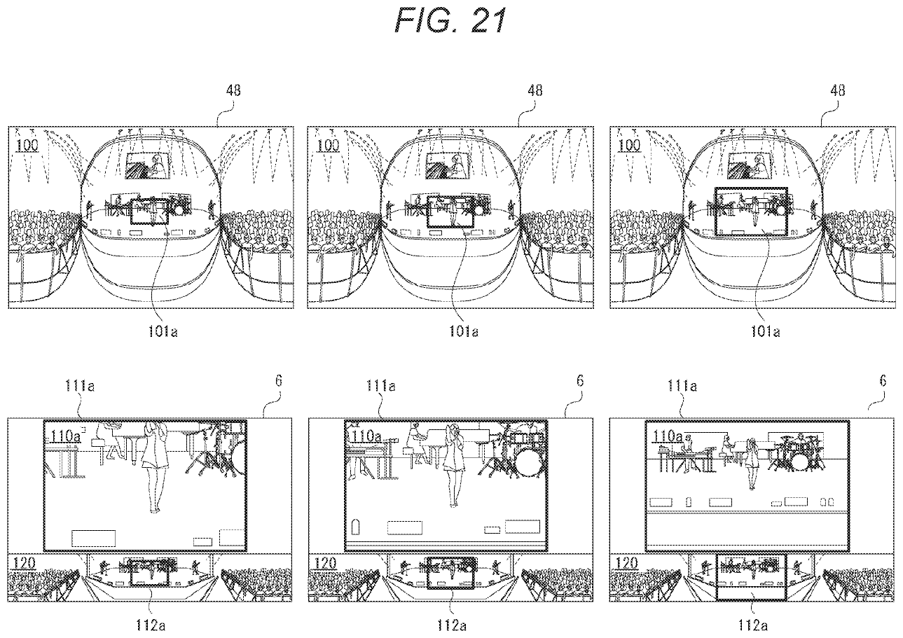

FIG. 21 is a diagram for explaining a display region corresponding to the resolution of the head mounted display 7. Note that FIG. 21 illustrates an example in which the resolution of the head mounted display 7 is low resolution, medium resolution, and high resolution in order from the left. In addition, FIG. 21 illustrates the case of the third display mode.

In Display Example 4, the display region 101 according to the resolution of the head mounted display 7 is determined, and the partial image 110 of the determined display region 101 is displayed on the external monitor 6.

Here, in the head mounted display 7, the resolution of the display varies depending on the type. Various resolutions such as video graphics array (VGA), full high definition (FHD), and quarter high definition (QHD) are used for the head mounted display 7.

Therefore, the storage unit 50 of the plane conversion device 4 stores resolution information for each type of the head mounted display 7. Then, when any one of the head mounted displays 7 is selected via the controller 5, the display region 101a is determined from the omnidirectional developed image 100 so as to have the resolution of the selected head mounted display 7.

For example, as illustrated on the left side of FIG. 21, in a case where the low-resolution head mounted display 7 is selected, the display region 101a also becomes small, and the relatively enlarged partial image 110a is displayed on the external monitor 6.

Furthermore, as illustrated in the center of FIG. 21, in a case where the medium resolution head mounted display 7 is selected, the display region 101a becomes larger than the low resolution, and the zoomed-out partial image 110a is displayed on the external monitor 6.

Furthermore, as illustrated on the right side of FIG. 21, in a case where the high-resolution head mounted display 7 is selected, the display region 101a is further enlarged as compared with the medium resolution, and the partial image 110a zoomed out is displayed on the external monitor 6.

As a result, it is possible to allow the user to confirm the partial image 110 displayed on the head mounted display 7 having different resolutions.

### 6-5. Display Example 5

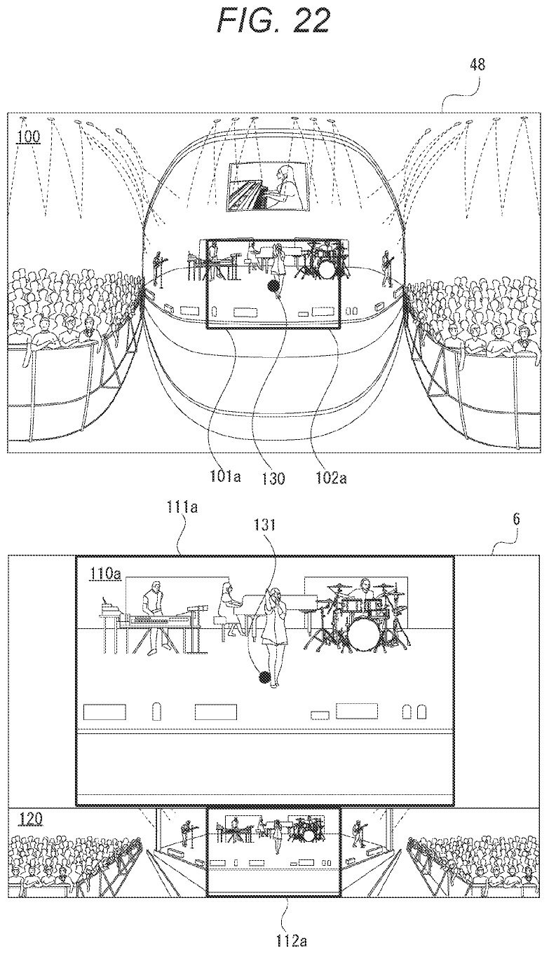

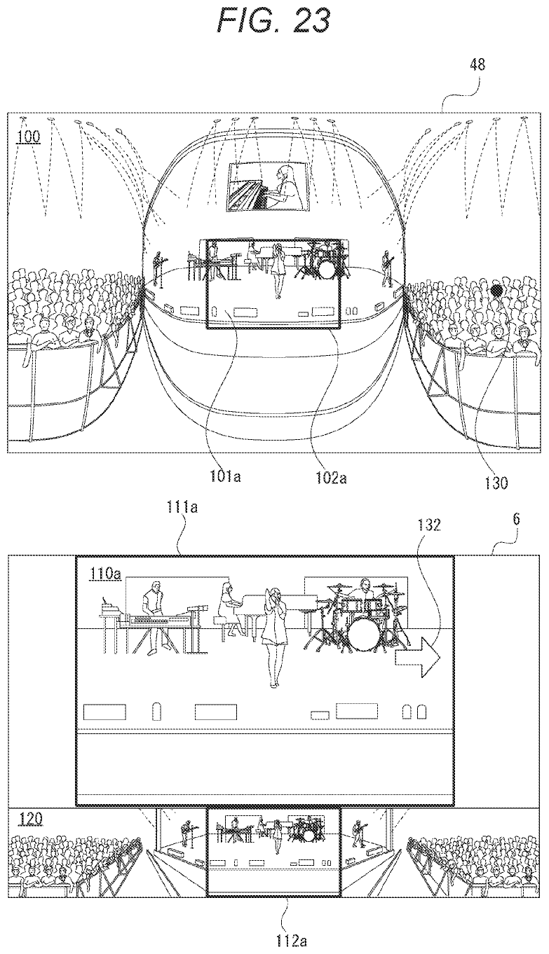

FIGS. 22 and 23 are diagrams for explaining an example of superimposing and displaying a mark corresponding to a predetermined position. Note that FIGS. 22 and 23 illustrate the case of the third display mode.

In Display Example 5, a mark corresponding to a predetermined position such as a center position set in the omnidirectional developed image 100 or a position selected by the user is superimposed and displayed on the omnidirectional developed image 100 and the partial image 110.

For example, as illustrated in FIG. 22, when a predetermined position is selected by a user operation on the controller 5 in the omnidirectional developed image 100 displayed on the display unit 48, the display control unit 64 superimposes and displays a mark 130 corresponding to the position on the omnidirectional developed image 100 on the display unit 48.

In addition, when the predetermined position is within the display region 101a, the display control unit 64 superimposes and displays a mark 131 corresponding to the predetermined position on the partial image 110a displayed on the external monitor 6 as illustrated in the lower part of FIG. 22.

In addition, when the predetermined position is outside the display region 101a, the display control unit 64 superimposes and displays a mark 132 such as an arrow indicating the direction of the predetermined position on the partial image 110 displayed on the external monitor 6 as illustrated in the lower part of FIG. 23.

As described above, the position selected by the user and the center position set in the omnidirectional developed image 100 are superimposed and displayed by the marks 130 and 131, and the mark 132 indicating the direction of the predetermined position is superimposed and displayed, whereby the predetermined position can be easily grasped by the user.

### 6-6. Display Example 6

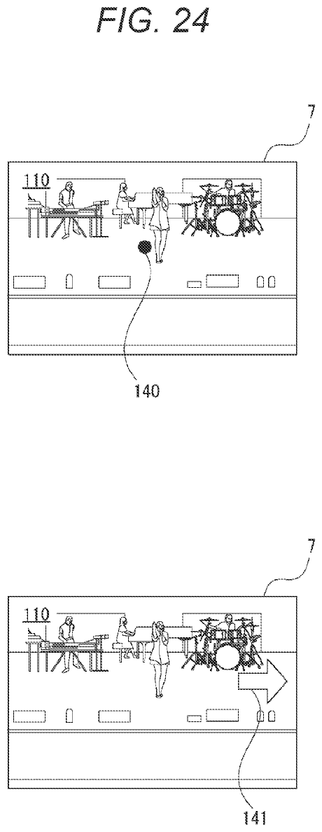

FIG. 24 is a diagram for explaining an example of superimposing and displaying a mark corresponding to a predetermined position on the head mounted display 7. In Display Example 6, a mark corresponding to the position selected by the user is superimposed and displayed on the partial image 110 of the head mounted display 7.

When a predetermined position is selected by a user operation on the controller 5, the display control unit 64 superimposes and displays the mark 130 corresponding to the position on the omnidirectional developed image 100 on the display unit 48, similarly to Display Example 5.

Further, when the predetermined position is within the display region 101 of the head mounted display 7, the display control unit 64 superimposes and displays a mark 140 indicating the predetermined position on the partial image 110 displayed on the head mounted display 7 as illustrated in the upper part of FIG. 24.

In addition, when the predetermined position is outside the display region 101 of the head mounted display 7, the display control unit 64 superimposes and displays a mark 141 such as an arrow indicating the direction of the predetermined position on the partial image 110 displayed on the head mounted display 7 as illustrated in the lower part of FIG. 24.

In this way, the wearer wearing the head mounted display 7 can easily grasp the predetermined position designated by the user. As a result, the wearer can move the head mounted display 7 to confirm the predetermined position designated by the user and display the partial image 110 corresponding to the position on the head mounted display 7.

### 6-7. Display Example 7

In Display Example 7, a mark corresponding to the line-of-sight position of the wearer wearing the head mounted display 7 is superimposed and displayed on the omnidirectional developed image 100 and the partial image 110.

When information indicating the line-of-sight position of the wearer is input from the head mounted display 7, the display control unit 64 superimposes and displays the mark 130 corresponding to the line-of-sight position on the omnidirectional developed image 100 in the omnidirectional developed image 100 displayed on the display unit 48 (see FIGS. 22 and 23), similarly to Display Example 5 and Display Example 6.

In addition, when the line-of-sight position is within the display region 101, the display control unit 64 superimposes and displays the mark 131 corresponding to the line-of-sight position on the partial image 110 displayed on the external monitor 6 (see FIG. 22).

In addition, when the line-of-sight position is outside the display region 101, the display control unit 64 superimposes and displays the mark 132 such as an arrow indicating the direction of the line-of-sight position on the partial image 110 displayed on the external monitor 6 (see FIG. 23).

In this way, the user can easily grasp the line-of-sight position of the wearer. As a result, the user can perform an operation such as displaying the partial image 110 corresponding to the line-of-sight position of the wearer on the external monitor 6 to confirm the partial image 110 corresponding to the line-of-sight position.

### 6-8. Display Example 8

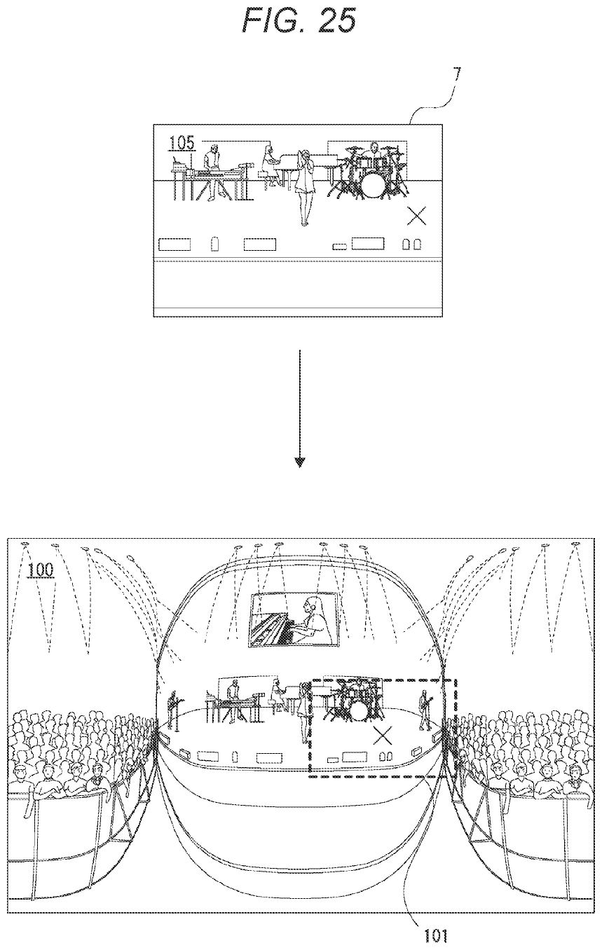

FIG. 25 is a diagram for explaining an example of display according to the line-of-sight position of the wearer. In Display Example 8, the partial image 110 centered on the line-of-sight position of the wearer wearing the head mounted display 7 is displayed on the external monitor 6.

For example, as illustrated in FIG. 25, when information indicating the line-of-sight position (indicated by a cross in the drawing) of the wearer is input from the head mounted display 7 to the display control unit 64, the display region determination unit 62 determines the display region 101 with the line-of-sight position as the center from the omnidirectional developed image 100.

The plane conversion unit 63 cuts out an image portion of the determined display region 101 from the omnidirectional developed image 100, and performs distortion correction processing on the cut out image portion to generate a partial image 110. Then, the display control unit 64 outputs the image signal of the partial image 110 to the external monitor 6 to display the partial image 110 corresponding to the line-of-sight position of the wearer on the external monitor 6.

In this way, by displaying the partial image 110 corresponding to the line-of-sight position of the wearer, it is possible to allow the user to easily confirm the image portion confirmed by the wearer.

### 6-9. Display Example 9

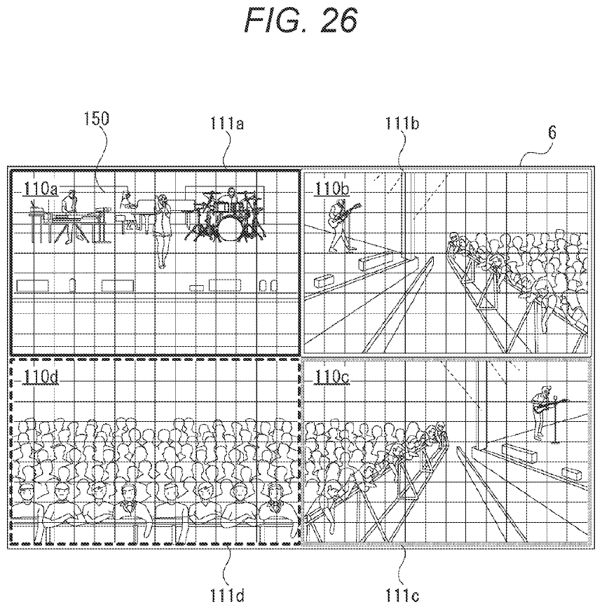

FIG. 26 is a diagram for explaining an example of superimposing and displaying the grid 150. Note that FIG. 26 illustrates the case of the second display mode. In Display Example 7, the grid 150 is superimposed and displayed on the partial image 110 displayed on the external monitor 6.

For example, as illustrated in FIG. 26, the display control unit 64 superimposes and displays grids 150 at predetermined intervals in the horizontal direction and the vertical direction on the partial images 110a to 110d.

In this way, the user can easily confirm the distortion of the partial image 110.

### 6-10. Display Example 10

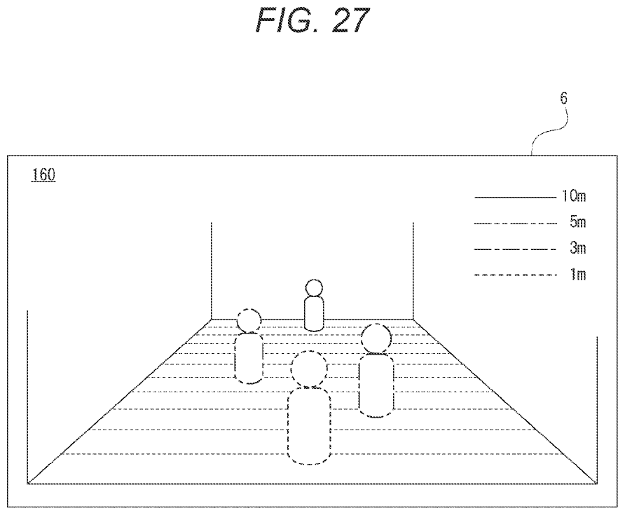

FIG. 27 is a diagram for explaining an example of displaying a parallax image as the partial image 110. In Display Example 10, the parallax image 160 is displayed as the partial image 110 displayed on the external monitor 6.

In a case where the omnidirectional camera device 2 can capture a parallax image, the VR conversion device 3 generates an omnidirectional developed image 100 as a parallax image. Then, the display control unit 64 causes the external monitor 6 to display the parallax image 160 as the partial image 110.

At this time, for example, as illustrated in FIG. 27, the parallax image 160 is displayed in different display modes depending on the distance.

Thus, the user can also confirm the distance to the three-dimensional object.

### 7. Modifications

Note that the embodiment is not limited to the specific examples described above and may be configured as various modifications.

In addition, the external monitor 6 has been described as an example of the editing status confirmation display unit. However, the editing status confirmation display unit may be the display unit 48 of the plane conversion device 4, or may be another display unit.

Furthermore, the display control unit 64 may switch and display partial images of different dynamic ranges. For example, the display control unit 64 may switch and display a standard dynamic range (SDR) partial image 110 and a high dynamic range (HDR) partial image 110. Further, the display control unit 64 may display the SDR partial image 110 and the HDR partial image 110 side by side on the external monitor 6.

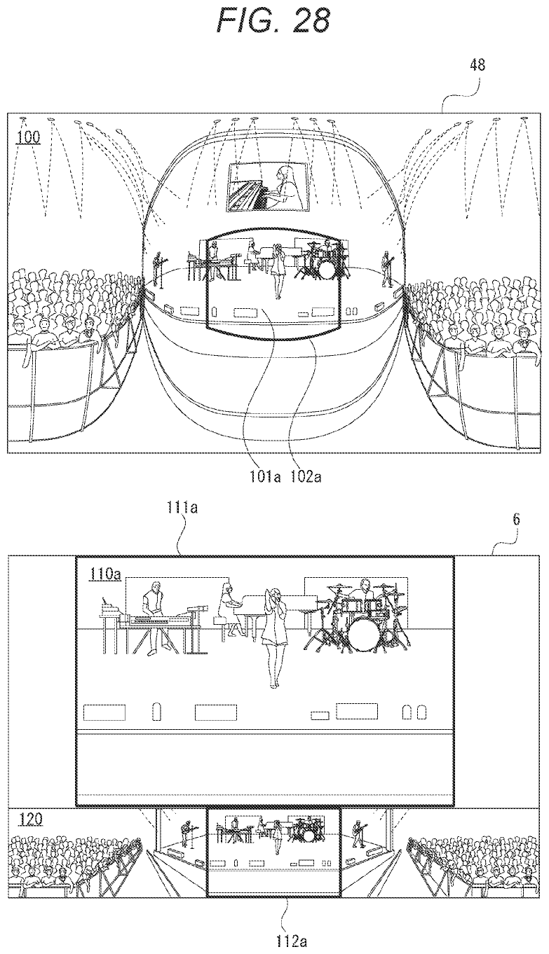

In addition, the case where the display frame 102 is square has been described. However, as illustrated in FIG. 28, the display frame 102 may have a shape that accurately represents the region displayed as the partial image 110 in consideration of being corrected by the distortion correction processing. Furthermore, the display control unit 64 may be capable of switching between a display frame 102 having a shape accurately representing a region displayed as the partial image 110 and a square display frame 102.

Furthermore, although the case where the VR conversion device 3 and the plane conversion device 4 are separate bodies has been described, the VR conversion device 3 and the plane conversion device 4 may be configured by one computer. For example, the plane conversion device 4 may also function as the EOTF unit 31, the VR conversion unit 32, the rendering unit 33, and the encoder unit 34 of the VR conversion device 3, and perform the generation processing of the omnidirectional developed image 100 performed by the VR conversion device 3.

Furthermore, the case where the input image is the omnidirectional developed image has been described. However, the input image desirably has an angle of view of at least 360 degrees in the horizontal direction, and may be a half celestial sphere developed image captured by one fisheye camera 2a, or may be a panorama image.

### 8. Summary

According to the above embodiment, the following effects can be obtained.

An image processing device (plane conversion device 4) according to an embodiment includes: a display region determination unit 62 that determines a first display region (display region 101a) and a second display region (display regions 101b to 101d) different from the first display region from an input image (omnidirectional developed image 100); and a display control unit 64 that causes an editing status confirmation display unit (external monitor 6) to display images of the first display region and the second display region determined by the display region determination unit as partial images 110.

As a result, the plane conversion device 4 can cause the user to confirm the partial image 110 other than the HMD partial image 105 (partial image 110a) confirmed by the wearer on the head mounted display 7. That is, the plane conversion device 4 can cause the wearer of the head mounted display 7 to confirm a region that is difficult to confirm in the omnidirectional developed image 100. Thus, the plane conversion device 4 can easily confirm the input image.

Furthermore, the input image is at least a part of the fisheye image, the image processing device includes: a VR conversion unit 32 that converts the input image into an equirectangular image; and a plane conversion unit 63 that converts an image of at least a first display region of the equirectangular image into a planar image, and the display control unit causes the editing status confirmation display unit to display the planar image as a partial image.

As a result, the plane conversion device 4 can confirm the equirectangular image having distortion with the partial image 110 in which the distortion has been corrected.

In addition, a region included in the first display region or the second display region is changed on the basis of a user operation targeting the image displayed on the editing status confirmation display unit.

As a result, the plane conversion device 4 can display the partial image of the region desired to be confirmed by the user on the external monitor 6, and can easily confirm the region desired to be confirmed.

In addition, the input image has an angle of view of at least 360 degrees in the horizontal direction, and the display region determination unit 62 sets, as the angle of view of the second display region in the horizontal direction, the angle of view obtained by equally dividing a range excluding the angle of view of the first display region from the angle of view of the input image in the horizontal direction by the number of the second display regions.

As a result, the plane conversion device 4 can cause the user to confirm all the angles of view in the horizontal direction of the omnidirectional developed image.

In addition, the input image has an angle of view of at least 360 degrees in the horizontal direction, and the display region determination unit 62 determines the second display region in a region diametrically opposite to the first display region in the horizontal direction.

As a result, the plane conversion device 4 can cause the user to confirm the partial image 110 of the display region 101 that is most difficult to confirm by the wearer wearing the head mounted display 7.

In addition, the display control unit 64 causes the editing status confirmation display unit to display a panorama image having an aspect ratio horizontally longer than the first display region and the second display region in the input image, together with the partial image.

As a result, the user can easily grasp which region of the partial image 110 of the omnidirectional developed image 100 is confirmed on the external monitor 6.

In addition, the display control unit 64 causes the display unit of the head mounted display 7 to display the partial image in the first display region.

As a result, the partial image 110 in a region that is difficult to confirm with the head mounted display 7 having a narrow viewing angle can be confirmed via the external monitor 6.

In addition, the display control unit 64 superimposes and displays a mark indicating a predetermined position on the partial image.

As a result, for example, the user can easily grasp the position designated by the user, the line-of-sight position of the wearer wearing the head mounted display 7, and the like.

In addition, the display control unit 64 superimposes and displays a grid on the partial image.

As a result, the user can easily confirm the distortion of the partial image 110.

In addition, the display control unit 64 displays the view angle information 113 indicating the angle of view of the partial image on the partial image.

As a result, it is possible to allow the user to easily grasp what kind of display region 101 is determined in the omnidirectional developed image 100 and what kind of partial image 110 of the display region 101 is displayed on the external monitor 6.

In addition, the display region determination unit 62 determines the display region including the tracking target on the basis of the information input from the tracking device 8 that tracks the predetermined tracking target.

As a result, by displaying the tracking target on the partial image 110 following the tracking target, the user can confirm the tracking target at any time.

In addition, the display control unit 64 displays a parallax image as a partial image.

Thus, the user can also confirm the distance to the three-dimensional object.

In addition, the display control unit 64 displays a mark 131 indicating the line-of-sight position of the wearer of the head mounted display in the partial image.

In this way, the user can easily grasp the line-of-sight position of the wearer. As a result, the user can perform an operation such as displaying the partial image 110 corresponding to the line-of-sight position of the wearer on the external monitor 6, and display the partial image corresponding to the line-of-sight position on the external monitor 6.

In addition, the display control unit 64 causes the display unit of the head mounted display to display the mark 140 corresponding to the position instructed by the operation unit in the input image.

As a result, the predetermined position designated by the user can be easily grasped by the wearer wearing the head mounted display 7. As a result, the wearer can move the head mounted display 7 to confirm the predetermined position designated by the user and display the partial image 110 corresponding to the position on the head mounted display 7.

The display region determination unit 62 determines a display region according to the resolution of the display unit of the head mounted display.

As a result, it is possible to cause the user to confirm the partial image 110 displayed on the head mounted display 7 having different resolutions.

The display region determination unit 62 moves the plurality of first display regions and the plurality of second display regions in conjunction with each other according to the operation of the operation unit.

As a result, the plurality of partial images 110 can be moved in conjunction with each other, and the trouble of the operation can be omitted.

The display region determination unit 62 enlarges or reduces a plurality of the first display region and the second display region in conjunction with each other according to an operation of the operation unit.

As a result, the plurality of partial images 110 can be enlarged or reduced in conjunction with each other, and the trouble of the operation can be omitted.

The display control unit 64 can display a plurality of partial images on the editing status confirmation display unit, and outputs signals of the plurality of partial images to the editing status confirmation display unit using different output units.

As a result, even in a case where the data amount of the image signal is large, the partial images 110 are individually output and displayed on the external monitor 6, so that it is possible to make it difficult to cause a delay in image display or the like. Furthermore, it is also possible to perform a Harding check on each partial image 110.

The display control unit switches and displays partial images of a plurality of types of dynamic ranges different from each other.

Thereby, the partial images 110 of various dynamic ranges can be confirmed.

In addition, in the image processing method, the image processing device determines the first display region and the second display region different from the first display region from the input image, and causes the editing status confirmation display unit to display the images of the determined first display region and second display region as partial images.

In addition, the program causes the image processing device to execute processing of determining the first display region and the second display region different from the first display region from the input image, and causing the editing status confirmation display unit to display the images of the determined first display region and second display region as partial images.

Such a program can be recorded in advance in an HDD as a storage medium built in a device such as a computer device, a ROM in a microcomputer having a CPU, or the like.

Alternatively, the program can be temporarily or permanently stored (recorded) in a removable storage medium such as a flexible disk, a compact disc read only memory (CD-ROM), a magneto optical (MO) disk, a digital versatile disc (DVD), a Blu-ray Disc (registered trademark), a magnetic disk, a semiconductor memory, or a memory card. Such a removable storage medium can be provided as so-called package software.

Furthermore, such a program can be installed from the removable storage medium into a personal computer or the like, or can be downloaded from a download site via a network such as a local area network (LAN) or the Internet.

In addition, such a program is suitable for providing the image processing device according to the embodiment in a wide range. For example, by downloading the program to a mobile terminal device such as a smartphone or a tablet, a mobile phone, a personal computer, a game device, a video device, a personal digital assistant (PDA), or the like, it is possible to cause the information processing device to function as the information processing device of the present technology.

Note that the effects described in the present specification are merely examples and are not limited, and other effects may be exerted.

### 9. Present Technology

Note that the present technology can also have the following configurations.
(1)

An image processing device including:
a display region determination unit that determines a first display region and a second display region different from the first display region from an input image; and
a display control unit that causes an editing status confirmation display unit to display images of the first display region and the second display region determined by the display region determination unit as partial images.

(2)

The image processing device according to (1), in which
the input image is at least a part of a fisheye image,
the image processing device includes:
a VR conversion unit that converts the input image into an equirectangular image; and
a plane conversion unit that converts an image of at least the first display region in the equirectangular image into a planar image, and
the display control unit causes the editing status confirmation display unit to display the planar image as the partial image.

(3)

The image processing device according to (1) or (2), in which
a region included in the first display region or the second display region is changed on the basis of a user operation targeting an image displayed on the editing status confirmation display unit.

(4)

The image processing device according to any one of (1) to (3), in which
the input image has an angle of view of at least 360 degrees in a horizontal direction, and
the display region determination unit is configured to
set an angle of view obtained by equally dividing a range excluding an angle of view of the first display region from an angle of view of the input image in a horizontal direction by the number of the second display regions as an angle of view of the second display region in a horizontal direction.

(5)

The image processing device according to any one of (1) to (4), in which
the input image has an angle of view of at least 360 degrees in a horizontal direction, and
the display region determination unit is configured to
determine the second display region in a region diametrically opposite to the first display region in a horizontal direction.

(6)

The image processing device according to any one of (1) to (5), in which
the display control unit is configured to
cause the editing status confirmation display unit to display a panorama image having an aspect ratio horizontally longer than the first display region and the second display region in a horizontal direction in the input image together with the partial image.

(7)

The image processing device according to any one of (1) to (6), in which
the display control unit is configured to
cause a display unit of a head mounted display to display the partial image in the first display region.

(8)

The image processing device according to any one of (1) to (7), in which
the display control unit is configured to
superimpose and display a mark indicating a predetermined position on the partial image.

(9)

The image processing device according to any one of (1) to (8), in which
the display control unit is configured to
superimpose and display a grid on the partial image.

(10)

The image processing device according to any one of (1) to (9), in which
the display control unit is configured to
superimpose and display view angle information indicating an angle of view of the partial image on the partial image.

(11)

The image processing device according to any one of (1) to (10), in which
the display region determination unit is configured to
determine a display region including a tracking target predetermined on the basis of information input from a tracking device that tracks the predetermined tracking target.

(12)

The image processing device according to any one of (1) to (11), in which
the display control unit is configured to
display a parallax image as the partial image.

(13)

The image processing device according to (7), in which
the display control unit is configured to
superimpose and display a mark corresponding to a line-of-sight position of a wearer of the head mounted display on the partial image.

(14)

The image processing device according to (7) or (13), in which
the display control unit is configured to
cause a display unit of the head mounted display to display a mark corresponding to a position instructed by an operation unit in the input image.

(15)

The image processing device according to (7), (13), or (14), in which
the display region determination unit is configured to
determine a display region according to resolution of a display unit of the head mounted display.

(16)

The image processing device according to any one of (1) to (15), in which
the display region determination unit is configured to
move a plurality of the first display region and the second display region in conjunction with each other according to an operation of an operation unit.

(17)

The image processing device according to any one of (1) to (16), in which
the display region determination unit is configured to
enlarge or reduce a plurality of the first display region and the second display region in conjunction with each other according to an operation of an operation unit.

(18)

The image processing device according to any one of (1) to (17), in which
the display control unit is configured to:
be able to display a plurality of the partial images on the editing status confirmation display unit; and
output signals of the plurality of the partial images to the editing status confirmation display unit using different output units.

(19)

The image processing device according to any one of (1) to (18), in which
the display control unit is configured to
switch and display the partial image of a plurality of types of dynamic ranges different from each other.

(20)

A display control method causing
an image processing device to:
determine a first display region and a second display region different from the first display region from an input image; and
cause an editing status confirmation display unit to display images of the first display region and the second display region determined as partial images.

(21)

A program for causing an image processing device to execute processing of:
determining a first display region and a second display region different from the first display region from an input image; and
causing an editing status confirmation display unit to display images of the first display region and the second display region determined as partial images.

### REFERENCE SIGNS LIST

1 Image processing system
3 VR conversion device
4 Plane conversion device
6 External monitor
7 Head mounted display
32 VR conversion unit
48 Display unit
62 Display region determination unit
63 Plane conversion unit
64 Display control unit

1. An image processing device comprising:
a display region determination unit that determines a first display region and a second display region different from the first display region from an input image; and
a display control unit that causes an editing status confirmation display unit to display images of the first display region and the second display region determined by the display region determination unit as partial images.

2. The image processing device according to claim 1, wherein
the input image is at least a part of a fisheye image,
the image processing device includes:
a VR conversion unit that converts the input image into an equirectangular image; and
a plane conversion unit that converts an image of at least the first display region in the equirectangular image into a planar image, and
the display control unit causes the editing status confirmation display unit to display the planar image as the partial image.

3. The image processing device according to claim 1, wherein
a region included in the first display region or the second display region is changed on a basis of a user operation targeting an image displayed on the editing status confirmation display unit.

4. The image processing device according to claim 1, wherein
the input image has an angle of view of at least 360 degrees in a horizontal direction, and
the display region determination unit is configured to
set an angle of view obtained by equally dividing a range excluding an angle of view of the first display region from an angle of view of the input image in a horizontal direction by the number of the second display regions as an angle of view of the second display region in a horizontal direction.

5. The image processing device according to claim 1, wherein
the input image has an angle of view of at least 360 degrees in a horizontal direction, and
the display region determination unit is configured to
determine the second display region in a region diametrically opposite to the first display region in a horizontal direction.

6. The image processing device according to claim 1, wherein
the display control unit is configured to
cause the editing status confirmation display unit to display a panorama image having an aspect ratio horizontally longer than the first display region and the second display region in a horizontal direction in the input image together with the partial image.

7. The image processing device according to claim 1, wherein
the display control unit is configured to
cause a display unit of a head mounted display to display the partial image in the first display region.

8. The image processing device according to claim 1, wherein
the display control unit is configured to
superimpose and display a mark indicating a predetermined position on the partial image.

9. The image processing device according to claim 1, wherein
the display control unit is configured to
superimpose and display a grid on the partial image.

10. The image processing device according to claim 1, wherein
the display control unit is configured to
superimpose and display view angle information indicating an angle of view of the partial image on the partial image.

11. The image processing device according to claim 1, wherein
the display region determination unit is configured to
determine a display region including a tracking target predetermined on a basis of information input from a tracking device that tracks the predetermined tracking target.

12. The image processing device according to claim 1, wherein
the display control unit is configured to
display a parallax image as the partial image.

13. The image processing device according to claim 7, wherein
the display control unit is configured to
superimpose and display a mark corresponding to a line-of-sight position of a wearer of the head mounted display on the partial image.

14. The image processing device according to claim 7, wherein
the display control unit is configured to
cause a display unit of the head mounted display to display a mark corresponding to a position instructed by an operation unit in the input image.

15. The image processing device according to claim 7, wherein
the display region determination unit is configured to
determine a display region according to resolution of a display unit of the head mounted display.

16. The image processing device according to claim 1, wherein
the display region determination unit is configured to
move a plurality of the first display region and the second display region in conjunction with each other according to an operation of an operation unit.

17. The image processing device according to claim 1, wherein
the display region determination unit is configured to
enlarge or reduce a plurality of the first display region and the second display region in conjunction with each other according to an operation of an operation unit.

18. The image processing device according to claim 1, wherein
the display control unit is configured to:
be able to display a plurality of the partial images on the editing status confirmation display unit; and
output signals of the plurality of the partial images to the editing status confirmation display unit using different output units.

19. The image processing device according to claim 1 wherein
the display control unit is configured to
switch and display the partial image of a plurality of types of dynamic ranges different from each other.

20. An image processing method causing
an image processing device to:
determine a first display region and a second display region different from the first display region from an input image; and
cause an editing status confirmation display unit to display images of the first display region and the second display region determined as partial images.

21. A program for causing an image processing device to execute processing of:
determining a first display region and a second display region different from the first display region from an input image; and
causing an editing status confirmation display unit to display images of the first display region and the second display region determined as partial images.
